(19) United States
(12) Patent Application Publication
(10) Pub. No.: US 2026/0320671 A1
(43) Pub. Date: Oct. 15, 2026

(54) INTERACTIVE RECOMMENDATIONS USING MULTIMODAL LARGE LANGUAGE MODELS

(71) Applicant: THE BOARD OF TRUSTEES OF THE UNIVERSITY OF ILLINOIS, Urbana, IL (US)

(72) Inventors: Theja TULABANDHULA, Chicago, IL (US); Saketh Reddy KARRA, Chicago, IL (US)

(21) Appl. No.: 19/460,552

(22) Filed: Jan. 27, 2026

Related U.S. Application Data
(60) Provisional application No. 63/750,486, filed on Jan. 28, 2025.

(51) Int. Cl. G06Q 30/0601

(52) U.S. Cl. CPC G06Q 30/06311

(57) ABSTRACT

With recent advancements in artificial intelligence, particularly the domain of large language models (LLMs), a compelling case emerges for developing a principled framework that could present a superior solution to the current dependency on weblogs. Disclosed is a screenshot-based user recommendation system that leverages information from screenshots of users' internet browsing activities. Our approach leverages multimodal large language models (MLLMs) adept at seamless processing and generating content across diverse modalities. By opting for screenshots as inputs instead of relying on weblogs, the system benefits from heightened interpretability. The visual nature of screenshots provides a lucid and transparent representation of user actions, significantly enhancing the comprehension of the inferences made by the LLM. Unlike weblogs, which may introduce complexities associated with various features, the use of screenshots simplifies the inputs, offering a more straightforward and intuitive approach. Furthermore, this method facilitates concurrent, real-time recommendations, as screenshots can be captured almost instantaneously.

### CROSS REFERENCE TO RELATED APPLICATIONS

The present application claims priority to U.S. Provisional Patent Application No. 63/750,486, filed Jan. 28, 2025, the disclosure of which is incorporated by reference in its entirety.

### BACKGROUND OF THE INVENTION

Weblogs, comprised of records detailing user activities on any website, offer valuable insights into user preferences, behavior, and interests. Numerous recommendation algorithms, employing strategies such as collaborative filtering, content-based filtering, and hybrid methods, leverage the data mined through these weblogs to provide personalized recommendations to users. Despite the abundance of information available in these weblogs, identifying and extracting pertinent information and key features requires significant engineering work. The intricate nature of the data also poses a challenge for interpretation, especially for non-experts.

In the evolving landscape of e-commerce, the need to understand user preferences for offering personalized content is increasingly crucial for online platforms to maximize revenue, build customer loyalty, and maintain competitive advantage. Typically, the nuanced information that can explain the user browsing behavior on these platforms is stored as weblogs (Rosenstein, 2000). Numerous state-of-the-art recommendation systems, employing strategies such as collaborative filtering, content-based filtering, and hybrid methods, leverage the data mined through these weblogs to provide personalized recommendations. This data-driven approach ensures that recommendations align closely with user preferences, contributing to a more seamless and satisfying shopping journey and ultimately increasing overall platform revenue.

Raw weblogs contain a wealth of information on key browsing session details, including start and end times, visited pages, and clickstream data. Beyond capturing fundamental details, these weblogs delve into user-specific data, encompassing identifiers and IP addresses. However, interpreting the raw web log data directly can be challenging for non-experts, requiring them to navigate its complexity and dissect it to build recommendation models. Often, sophisticated data engineering techniques are necessary to extract the relevant features and datasets needed for training these models. With recent advancements in artificial intelligence, particularly within the domain of LLMs (Zhao et al., 2023), a compelling case emerges for developing a principled framework that could present a superior solution to the current dependency on weblogs.

Recommendation systems are widely used applications on ecommerce websites, where it suggests relevant products to users based on their past browsing behavior, purchase history, and preferences, acting as a virtual salesperson to help customers discover items of interest; this is often seen as a “Customers who bought this also bought” section on product pages. The sheer size of the data mined by recommendations systems means that real time use during a browsers experience may be limited.

Addressing the above issues with processing weblogs, we propose an innovative approach leveraging the screenshots of users' browsing activities. By opting for screenshots instead of relying on weblogs, the system can benefit from heightened interpretability. Notably, the visual nature of screenshots offer a lucid and transparent representation of user actions, thus significantly enhancing the ability to draw meaningful insights. In contrast to processing weblogs, which can introduce complexities associated with extracting various features, screenshots simplify the inputs, making it a more straightforward and intuitive process. Additionally, harnessing screenshots instead of weblogs facilitates real-time personalization, benefiting from the near-instantaneous capture of screenshots.

Utilizing screenshots to generate personalized recommendations necessitates additional processing. With recent advancements in the domain of LLMs, particularly LLMs have shown impressive capabilities in performing complex tasks ranging from open world image understanding to interpreting memes. Due to their strong reasoning and in-context learning abilities, numerous researchers have been exploring their applications in both academia and industry. This provides a compelling case for developing a robust framework using LLMs to process screenshots, presenting a superior alternative to relying solely on weblogs.

Thus, there is a critical need for a framework which diverges from conventional approaches by leveraging state-of-the-art multimodal large language models (MLLMs) and limits the need for identifying and extracting pertinent information and key features necessitates extensive engineering endeavors and simplifies data and eases the challenge of interpretation and allowing the user to experience the recommendations made in real time.

### SUMMARY OF THE INVENTION

Disclosed herein is a sophisticated and interactive recommendation framework denoted as InteraRec, which diverges from conventional approaches that exclusively depend on weblogs for recommendation generation. This framework captures high-frequency screenshots of web pages as users navigate through a website. Leveraging state-of-the-art multimodal large language models (MLLMs), it extracts valuable insights into user preferences from these screenshots by generating a user behavioral summary based on predefined keywords.

Thus, in one exemplary embodiment, disclosed is a system for interactive recommendations comprising: obtaining screenshots of user browsing; a behavioral summarization of the users' browsing history; and a response generation reply to the user providing browser suggestions based on the behavioral summarization; wherein an automated script systematically captures high-frequency screenshots of web pages visited by the user; wherein a multimodal large language model (MLLM) uses the screen shots to create a summary of screenshots using predefined keywords; wherein a large language model (LLM) transforms the summary into specific constraints/preferences intelligible to optimization tools; and wherein the LLM recommends the preferences to the user via the LLM interface.

In various embodiments the screenshots are confined to the users' viewing area. In these embodiments, the screenshots target the visible content that users actively engage with. In various embodiments, the MLLM creates a summary of the users' browser interaction using the screenshots. In these embodiments the summary is used to identify predefined categories of the users' screenshots. In various embodiments, the categories include product characteristics comprising lowest and highest prices, brand preferences, product specifications, user reviews, comparisons, and promotions.

In still other embodiments the user summary is deconstructed into relevant constraints/preferences to generate optimal recommendations. In various embodiments, the LLM uses function-calling capabilities to decompose the user interaction summary into relevant constraints/preferences using functions comprising (FIG. 4): “name”: “get_user_recommendations”, “description”: “Generate dynamic recommendation based/the summary of user behavior”. In various embodiments, the LLM provides validations checks comprising range and consistency assessment of the decomposed constraints. In yet other embodiments, the LLM incorporates results of the summary as input to the user. In various embodiments, wherein the LLM is gpt-3.5-turbo. In various other embodiments, the MLLM is gpt-4-vision.

In yet other embodiments, disclosed in a software package comprising the interactive recommendations described above.

These and other features and advantages of this invention will be more fully understood from the following detailed description of the invention taken together with the accompanying claims. It is noted that the scope of the claims is defined by the recitations therein and not by the specific discussion of features and advantages set forth in the present description.

### BRIEF DESCRIPTION OF DRAWINGS

The following drawings form part of the specification and are included to further demonstrate certain embodiments or various aspects of the invention. In some instances, embodiments of the invention can be best understood by referring to the accompanying drawings in combination with the detailed description presented herein. The description and accompanying drawings may highlight a certain specific example, or a certain aspect of the invention. However, one skilled in the art will understand that portions of the example or aspect may be used in combination with other examples or aspects of the invention.

FIG. 1: Schematic representation of the InteraRec framework.

FIG. 2: Overview of three stages of InteraRec framework.

FIG. 3: Guidelines for MLLM to generate a summary of user interactions using predefined keywords.

FIG. 4: Prospective function for decomposing user interaction summaries.

FIG. 5: Session-based recommendations with InteraRec framework.

FIG. 6: Six screen captures showcasing user interactions with the Asos.com website, each captured at a 1-second interval.

FIG. 7: Extracted summary from Asos website activities revealing a user preference for green dresses, diverse brand interest, and price sensitivity.

FIG. 8: Nine screen captures showcasing user interactions with the Nike.com website, each captured at a 4-second interval.

FIG. 9: Extracted summary of user preferences shaped by activities on the Nike.com website.

FIG. 10: Four screen captures showcasing user interactions with the Zillow.com website, each captured at a 10-second interval.

FIG. 11: Extracted summary of user preferences shaped by activities on the Zillow.com website.

FIG. 12: InteraRec Real-time recommendations incorporating the dynamic user behavior.

FIG. 13: Distribution of session sizes in our session-based screenshot dataset.

FIG. 14: Screenshots from a user browsing session on the Amazon website.

FIG. 15: Ranking performance of baseline models with and without InteraRec.

FIG. 16: Impact of augmenting the training data on ranking performance of baseline models.

FIG. 17: Impact of augmenting the training data on ranking performance of baseline models with InteraRec framework.

FIG. 18: Impact of screenshot type on ranking performance of baseline models with InteraRec framework.

FIG. 19: Impact of limiting the session size on ranking performance of baseline models with InteraRec framework.

### DETAILED DESCRIPTION

In the evolving landscape of e-commerce, the need to understand user preferences for offering personalized content is increasingly crucial for online platforms to maximize revenue, build customer loyalty, and maintain competitive advantage. Typically, the nuanced information that can explain the user browsing behavior on these platforms is stored as weblogs. Raw weblogs contain a wealth of information on key browsing session details, including start and end times, visited pages, and clickstream data. However, interpreting the raw web log data directly is challenging for non-experts, requiring them to navigate its complexity and dissect it to build recommendation models. Often, sophisticated data engineering techniques are necessary to extract the relevant features and datasets needed for training these models. With recent advancements in artificial intelligence, particularly within the domain of large language models (LLMs), a compelling case emerges for developing a principled framework that could present a superior solution to the current dependency on weblogs. Inspired by the above, we propose a novel screenshot-based user recommendation system that leverages information from screenshots of users' internet browsing activities. Our approach leverages multimodal large language models (MLLMs) adept at seamless processing and generating content across diverse modalities. By opting for screenshots as inputs instead of relying on weblogs, the system benefits from heightened interpretability. The visual nature of screenshots provides a lucid and transparent representation of user actions, significantly enhancing the comprehension of the inferences made by the LLM. Unlike weblogs, which may introduce complexities associated with various features, the use of screenshots simplifies the inputs, offering a more straightforward and intuitive approach. Furthermore, this method facilitates concurrent, real-time recommendations, as screenshots can be captured almost instantaneously.

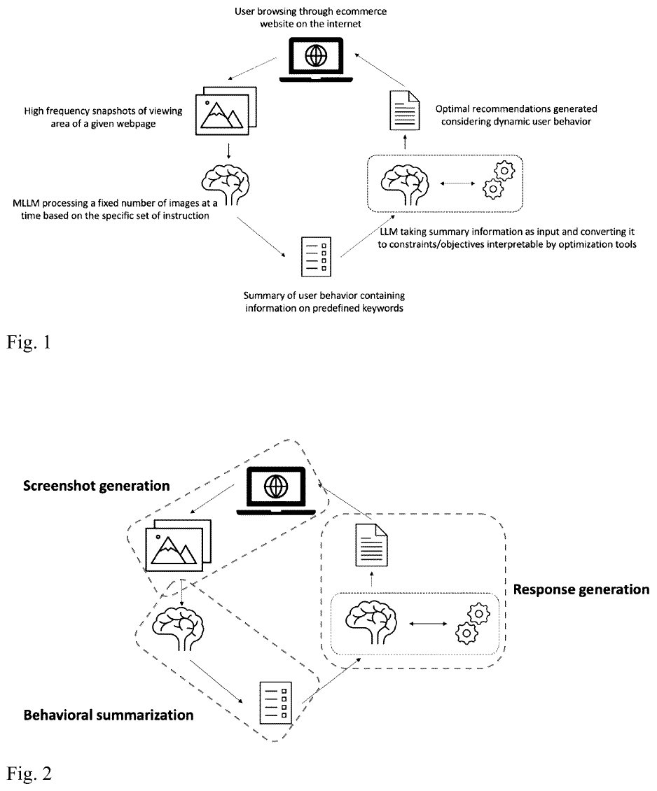

Inspired by the above, we introduce InteraRec, a novel screenshot-based recommendation framework as shown in FIG. 1. InteraRec initiates by capturing high-frequency screenshots of web pages as users navigate them in real-time. Subsequently, an MLLM processes these screenshots to extract meaningful insights into user behavior. These insights are then utilized in an LLM-integrated optimization setup to generate relevant and personalized recommendations. By seamlessly integrating visual data, language models, and optimization tools, InteraRec surpasses the limitations of existing systems, offering a more personalized and effective recommendation experience for users.

The following definitions are included to provide a clear and consistent understanding of the specification and claims. As used herein, the recited terms have the following meanings. All other terms and phrases used in this specification have their ordinary meanings as one of skill in the art would understand. Such ordinary meanings may be obtained by reference to technical dictionaries, such as Computer Hope (https://www.computerhope.com), or the Computer Dictionary of Information Technology (https://www.computer-dictionary-online.org/).

References in the specification to “one embodiment”, “an embodiment”, etc., indicate that the embodiment described may include a particular aspect, feature, structure, moiety, or characteristic, but not every embodiment necessarily includes that aspect, feature, structure, moiety, or characteristic. Moreover, such phrases may, but do not necessarily, refer to the same embodiment referred to in other portions of the specification. Further, when a particular aspect, feature, structure, moiety, or characteristic is described in connection with an embodiment, it is within the knowledge of one skilled in the art to affect or connect such aspect, feature, structure, moiety, or characteristic with other embodiments, whether or not explicitly described.

The singular forms “a,” “an,” and “the” include plural reference unless the context clearly dictates otherwise. Thus, for example, a reference to “a system” includes a plurality of such systems, so that a system X includes a plurality of systems X. It is further noted that the claims may be drafted to exclude any optional element. As such, this statement is intended to serve as antecedent basis for the use of exclusive terminology, such as “solely,” “only,” and the like, in connection with any element described herein, and/or the recitation of claim elements or use of “negative” limitations.

The term “and/or” means any one of the items, any combination of the items, or all of the items with which this term is associated. The phrases “one or more” and “at least one” are readily understood by one of skill in the art, particularly when read in context of its usage. For example, the phrase can mean one, two, three, four, five, six, ten, 100, or any upper limit approximately 10, 100, or 1000 times higher than a recited lower limit.

As will be understood by the skilled artisan, all numbers, including those expressing quantities of ingredients, properties such as molecular weight, reaction conditions, and so forth, are approximations and are understood as being optionally modified in all instances by the term “about.” These values can vary depending upon the desired properties sought to be obtained by those skilled in the art utilizing the teachings of the descriptions herein. It is also understood that such values inherently contain variability necessarily resulting from the standard deviations found in their respective testing measurements. When values are expressed as approximations, by use of the antecedent “about,” it will be understood that the particular value without the modifier “about” also forms a further aspect.

The terms “about” and “approximately” are used interchangeably. Both terms can refer to a variation of ±5%, ±10%, ±20%, or ±25% of the value specified. For example, “about 50” percent can in some embodiments carry a variation from 45 to 55 percent, or as otherwise defined by a particular claim. For integer ranges, the term “about” can include one or two integers greater than and/or less than a recited integer at each end of the range. Unless indicated otherwise herein, the terms “about” and “approximately” are intended to include values, e.g., weight percentages, proximate to the recited range that are equivalent in terms of the functionality of the individual ingredient, composition, or embodiment. The terms “about” and “approximately” can also modify the endpoints of a recited range as discussed above in this paragraph.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. It is therefore understood that each unit between two particular units is also disclosed. For example, if 10 to 15 is disclosed, then 11, 12, 13, and 14 are also disclosed, individually, and as part of a range. A recited range (e.g., weight percentages or carbon groups) includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc. As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio. Accordingly, specific values recited for radicals, substituents, and ranges, are for illustration only; they do not exclude other defined values or other values within defined ranges for radicals and substituents. It will be further understood that the endpoints of each of the ranges are significant both in relation to the other endpoint, and independently of the other endpoint.

This disclosure provides ranges, limits, and deviations to variables such as volume, mass, percentages, ratios, etc. It is understood by an ordinary person skilled in the art that a range, such as “number 1” to “number 2”, implies a continuous range of numbers that includes the whole numbers and fractional numbers. For example, 1 to 10 means 1, 2, 3, 4, 5, . . . 9, 10. It also means 1.0, 1.1, 1.2. 1.3, . . . , 9.8, 9.9, 10.0, and also means 1.01, 1.02, 1.03, and so on. If the variable disclosed is a number less than “number 10”, it implies a continuous range that includes whole numbers and fractional numbers less than number 10, as discussed above. Similarly, if the variable disclosed is a number greater than “number 10”, it implies a continuous range that includes whole numbers and fractional numbers greater than number 10. These ranges can be modified by the term “about”, whose meaning has been described above.

One skilled in the art will also readily recognize that where members are grouped together in a common manner, such as in a Markush group, the invention encompasses not only the entire group listed as a whole, but each member of the group individually and all possible subgroups of the main group. Additionally, for all purposes, the invention encompasses not only the main group, but also the main group absent one or more of the group members. The invention therefore envisages the explicit exclusion of any one or more of members of a recited group. Accordingly, provisos may apply to any of the disclosed categories or embodiments whereby any one or more of the recited elements, species, or embodiments, may be excluded from such categories or embodiments, for example, for use in an explicit negative limitation.

The term “substantially” as used herein, is a broad term and is used in its ordinary sense, including, without limitation, being largely but not necessarily wholly that which is specified. For example, the term could refer to a numerical value that may not be 100% the full numerical value. The full numerical value may be less by about 1%, about 2%, about 3%, about 4%, about 5%, about 6%, about 7%, about 8%, about 9%, about 10%, about 15%, or about 20%.

Wherever the term “comprising” is used herein, options are contemplated wherein the terms “consisting of” or “consisting essentially of” are used instead. As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the aspect element. As used herein, “consisting essentially of” does not exclude materials or steps that do not materially affect the basic and novel characteristics of the aspect. In each instance herein any of the terms “comprising”, “consisting essentially of” and “consisting of” may be replaced with either of the other two terms. The disclosure illustratively described herein may be suitably practiced in the absence of any element or elements, limitation, or limitations not specifically disclosed herein.

As used herein, the acronym MLLM refers to a Multimodal Large Language Model which is a model that merges the reasoning capabilities of Large Language Models (LLMs), for instance GPT-3 [2] or LLaMA-3 [3], with the ability to receive, reason, and output with multimodal information. As used herein, the term “constraints” is a term of art in the browser recommendation field referring to the preferences or likes of a user on an internet browser.

A recommender system uses machine learning and data filters to organize search results in a way that is most relevant to the end-user. The order of search results can be based on user preferences, behaviors, or other relevant factors.

Many websites such as TikTok, Netflix, Spotify, LinkedIn, Nike et. use recommender systems. With the help of machine learning and artificial intelligence, a recommendation system can make almost any website, ecommerce experience, or app provide personalized recommendations or suggestions from the website while the user is browsing.

Because they can show product and content recommendations in any webpage, community, marketplace, or digital property, recommender systems stand to drastically reduce friction by seamlessly guiding users from retrieval to discovery. It can help people solve problems faster by displaying related support articles, videos, and community posts. According to a report from the customer experience industry 33% of respondents said getting recommendations for content that has been helpful to others with a similar problem would improve their digital experience. Recommendations can improve click-through with auto-populated suggestions and predictive offers, too, as well as maximize cart value with trending, frequently bought together, buy-again, and other recommendation strategies: 45% of website visitors are motivated by customer reviews, recommendations for complementary items, or “#people have bought this” displays.

A recommender system typically relies on advanced search and one or more AI models to analyze aggregate and individual user data. It uses this information to deliver the most relevant content and products to a given visitor. These recommender systems require as much content and user data as possible to continuously learn and refine its personalized recommendations. This data can include: user behavior, user preference, user item interaction, search query data and content index. Those of skill in the art will appreciate that such enormous amount of data requires huge amount of memory, storage and time. Thus, a recommender system that can be as efficient as possible with less data Constraints in a recommender system are the requirements or preferences that a user has for items. Recommender systems use constraints to find items that match a user's preference. Even with moder AI utilizing up to date MLLMs and LLMs the ability to manipulate the data and enhance the users' experience takes time and the ability to make recommendations to the user in real time is often based on the length of the users stay.

As used herein the term “Decomposed constraints” are constraints or preferences that have been broken down into smaller, more manageable subproblems. This process is called decomposition, and it's a general technique for solving problems and designing algorithms.

Disclosed is a screenshot-based user interactive recommendation system called InteraRec. We capture high-frequency screenshots of web pages as users navigate through them in real-time. Leveraging the capabilities of MLLMs, InteraRec processes these screenshots to extract meaningful insights into user behavior and execute pertinent optimization tools to deliver personalized recommendations. By seamlessly integrating visual data, language models, and optimization tools, InteraRec transcends the limitations of existing systems, promising a more personalized and effective recommendation system for users.

### The InteraRec Framework

Addressing the challenge of offering real-time recommendations to users is a multi-step process. It typically commences with thorough data collection and analysis, followed by the careful selection and training of appropriate user behavior models. After a rigorous evaluation, the trained model is deployed to generate optimal recommendations. The user is then empowered to make a decision, choosing whether to act upon or disregard the presented recommendations.

Our framework InteraRec initiates by capturing screenshots of a user's browsing activity on a website at regular intervals. Subsequently, an MLLM, with its inferential capabilities, translates user interaction behavior from screenshots to a text summary comprising of information on predefined keywords. The InteraRec framework then leverages a suitable recommendation system to extract user preferences based on this summary and generate tailored recommendations. The process outlined above is organized into multiple stages: 1) Screenshot generation, 2) Behavioral summarization, and 3) Response generation as shown in FIG. 2.

### Screenshot Generation

InteraRec initiates an automated script to systematically capture high-frequency, high-quality screenshots of the web pages users navigate during a browsing session. Notably, the screenshots are confined to the user's current viewing area on the screen rather than encompassing the full scrollable content of each webpage. This allows for efficient targeting of the visible content that users actively engage with. InteraRec then stores these representative screenshots in a database for further processing and analysis.

### Behavioral Summarization

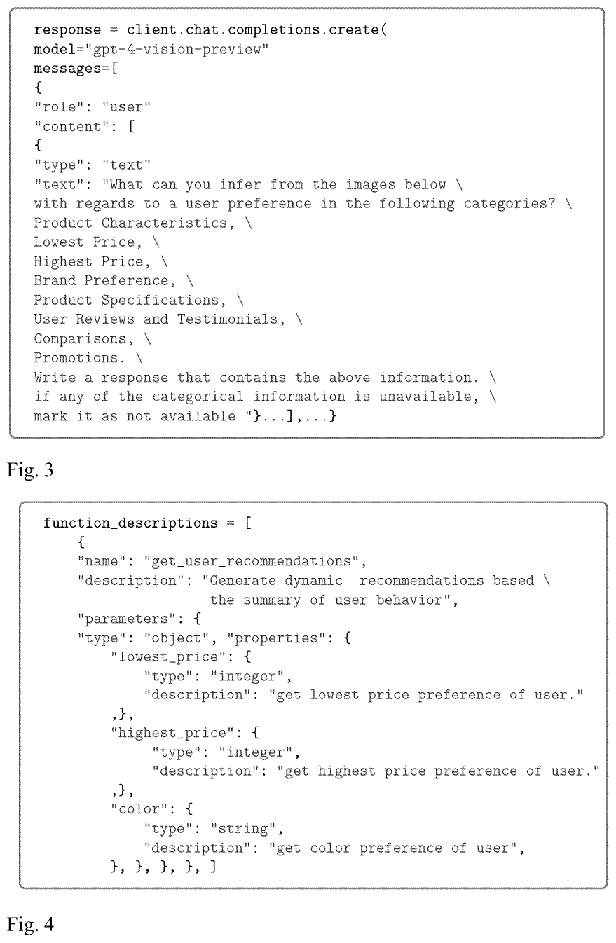

In this stage, InteraRec sequentially processes a finite number of screenshots in real-time using an MLLM to analyze and provide detailed responses. Specifically, InteraRec instructs the MLLM to succinctly summarize user interaction behavior across predefined categories such as product characteristics, lowest and highest prices, brand preferences, product specifications, user reviews, comparisons, and promotions as shown in FIG. 3. This precise instruction is crucial to filter the information and capture elements directly aligned with user interests. Generic instructions like “describe the user behavior on screenshots” or “explain the differences in screenshots” yielded responses that lacked specificity and failed to reflect user preferences. If the model cannot deduce information for a given category, InteraRec generates a response indicating ‘does not know’ or ‘not applicable.’ Additionally, InteraRec ensures that the model presents information in a summarized JavaScript Object Notation (JSON) format, facilitating its use as a constraint or filter for subsequent processing.

### Response Generation

The keyword-based summary generated from the previous stage is rich in information, forming a valuable resource for generating recommendations. The relevant information extracted from the summary depends on the capabilities of the recommendation methods that can incorporate them. In this study, InteraRec harnesses the InteraSSort framework (Karra and Tulabandhula, 2023) to deconstruct the user behavior summary into relevant constraints and uses them to solve an assortment optimization problem to generate optimal recommendations. Specifically, InteraRec leverages the function-calling capabilities of the LLM to decompose the user interaction summary into relevant constraints using appropriate functions as shown in FIG. 4. Subsequently, rigorous validation checks are conducted, encompassing range and consistency assessments of the decomposed constraints. InteraRec maintains an extensive database containing parameters for discrete choice models estimated using historical purchase transactions. By leveraging these choice model parameters and additional constraints as arguments, InteraRec executes optimization scripts employing tools like optimization solvers to generate optimal solutions. Ultimately, InteraRec empowers the LLM to incorporate these results as input, generating user-friendly personalized product recommendations.

Special Case of Response Generation with Session-Based Recommendation Model

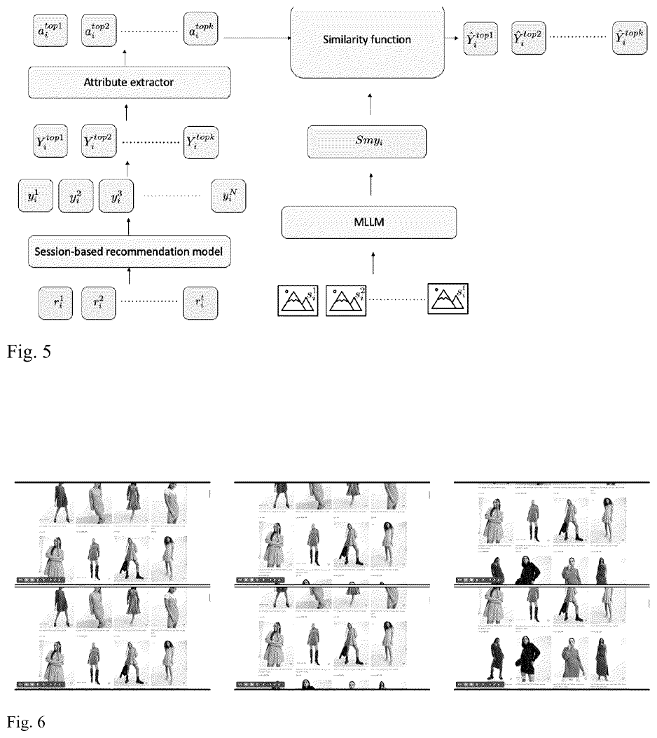

The response generation stage of the InteraRec framework can be seamlessly integrated with existing recommendation systems to enhance their overall performance and effectiveness. Specifically, we explore the integration of session-based recommender models within the InteraRec framework. The schematic diagram in FIG. 5 illustrates the proposed setup, which combines the strengths of the InteraRec framework and session-based recommender models to deliver superior recommendations.

Session-based recommendation aims to predict the items a user is most likely to engage with next, given their chronological sequence of interactions during a browsing session. Let Rᵢ=[r¹ᵢ, . . . , r^{t}ᵢ] represent the sequence of t items the user has interacted with (e.g., clicked, purchased) in session i. A session-based recommendation model takes Rᵢ as input and outputs Yᵢ=[y¹ᵢ, . . . , y^{N}ᵢ], where yⁱᵢ is the prediction probability of the user interacting with item j in the subsequent time step. The model's performance is then evaluated by comparing the top-k ranked items in Yᵢ, denoted as

$$[ {\hat{y}}_{i}^{top 1} , … , {\hat{y}}_{i}^{t o p k} ] ,$$

against the ground truth data.

Given the top-k ranked items, we employ a re-ranking strategy that incorporates the user's browsing context, derived from screenshots of web pages viewed during their session, using the InteraRec framework. This approach re-ranks the initial top ranked predictions from the session-based recommendation model, leveraging the contextual information extracted from the screenshots to better align the recommendations with the user's intent and browsing behavior. Specifically, we collect the screenshots of item web pages corresponding to the user's past interactions in the current session, denoted as

$${S}_{i} = [ {s}_{i}^{l} , … , {s}_{i}^{t} ] ,$$

where sⁱᵢ represents the screenshot of the j-th item interacted with. The MLLM component of InteraRec processes these screenshots to generate a keyword summary Smyᵢ, capturing the user's interests and preferences during the session. Additionally, each item has associated attributes such as color, brand, price, title, etc. For the top-k ranked item predictions, we extract the concatenated textual attributes, denoted as

$$[ {a}_{i}^{t o p 1} , … , {a}_{i}^{t o p k} ] ,$$

where

$${a}_{i}^{topj}$$

represents the attributes of the j-th ranked item.

We leverage a sentence embedding model to obtain vector representations for both the keyword summary and the concatenated text attributes. By computing the cosine similarity between the summary embeddings and the attribute embeddings of each top-ranked item, we re-rank the initial predictions in descending order of their similarity scores. This re-ranking process yields the final ranked list

$$[ {\hat{y}}_{i}^{top 1} , … , {\hat{y}}_{i}^{topk} ] .$$

By aligning the recommendations with the user's interests and preferences, captured by the keyword summary derived from their browsing session, we ensure that the final recommendations are highly relevant and personalized to the users.

### Illustration

In this section, we discuss the components needed to run our experiments, followed by an illustrative example.

### Examples

The present invention is further illustrated and supported by the following examples. However, these examples should in no way be considered to further limit the scope of the invention. To the contrary, one having ordinary skill in the art would readily understand that there are other embodiments, modifications, and equivalents of the present invention without departing from the spirit of the present invention and/or the scope of the appended claims.

### Example Demonstration of InteraRec Framework

In this example, we configure the InteraRec framework to solve the assortment planning problem under a discrete choice model to generate the personalized recommendations as discussed below.

### Assortment Planning

The assortment planning problem involves choosing an assortment among a set of feasible assortments(S) that maximizes the expected revenue. Consider a set of products indexed from 1 to n with their respective prices being p₁, p₂, . . . pₙ. The revenue of the assortment is given by R(S)=>Σ_{k∈S}pₖ× [symbol] (k|S) where S⊆{1, . . . , n}. The expected revenue maximization problem is simply: maxse_{S∈S}R(S). Here [symbol] (k|S) represents the probability that a user chooses product k from an assortment S and is determined by a choice model.

The complex nature of the assortment planning problem requires the development of robust optimization methodologies that can work well with different types of constraints and produce viable solutions within reasonable time frames. In our experiments, we adopt a series of scalable efficient algorithms (Tulabandhula et al., 2022) for solving the assortment optimization problem.

### Multinomial Logit (MNL)

The MNL model (Luce, 2012) is one of the most extensively studied discrete choice models and is frequently utilized across various marketing applications. The parameters of the MNL model are represented by a vector v=(v₀, v₁, . . . vₙ) with 0≤vᵢ≤1 ∀i. Parameter vᵢ, 1≤i≤n, captures the user preference for purchasing product i. Under this model, the probability that a user chooses product k from an assortment S is given by [symbol] (k S)=vₗ/(v₀+Σ_{k′∈S}v_{k′}).

### LLM

We employ the gpt-4-vision-preview (GPT-4V) and gpt-3.5-turbo variants from the GPT model series as our MLLM and LLM, respectively. Both the models are publicly accessible through the OpenAI API¹.

### Multinomial Logit (MNL)

The MNL model is one of the most extensively studied discrete choice models and is frequently utilized across various marketing applications. The parameters of the MNL model are represented by a vector v=(v0, v1, . . . vn) with 0≤vi≤1 ∀i. Parameter vi, 1≤i≤n, captures the user preference for purchasing item i. Under this model, the probability that a user chooses item k from an assortment S is given by P(k|S)=v1/(v0+Σk′∈S vk′).

### Model Settings

We employ the gpt-4-vision-preview (GPT-4V) and gpt-3.5-turbo variants from the GPT model series as our MLLM for processing screenshots and LLM for decomposing the keyword summary respectively. Both the models are publicly accessible through the OpenAI API 1.

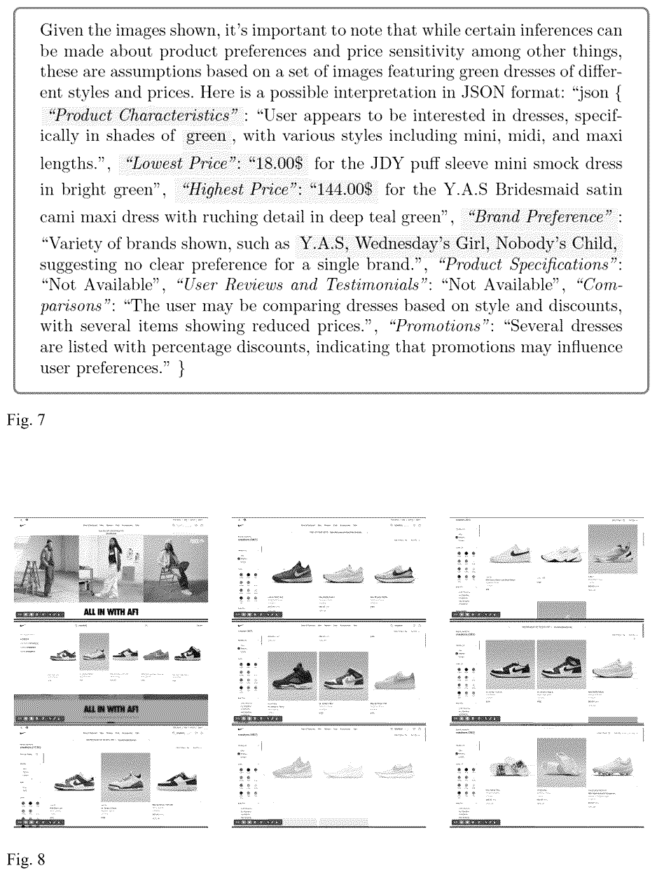

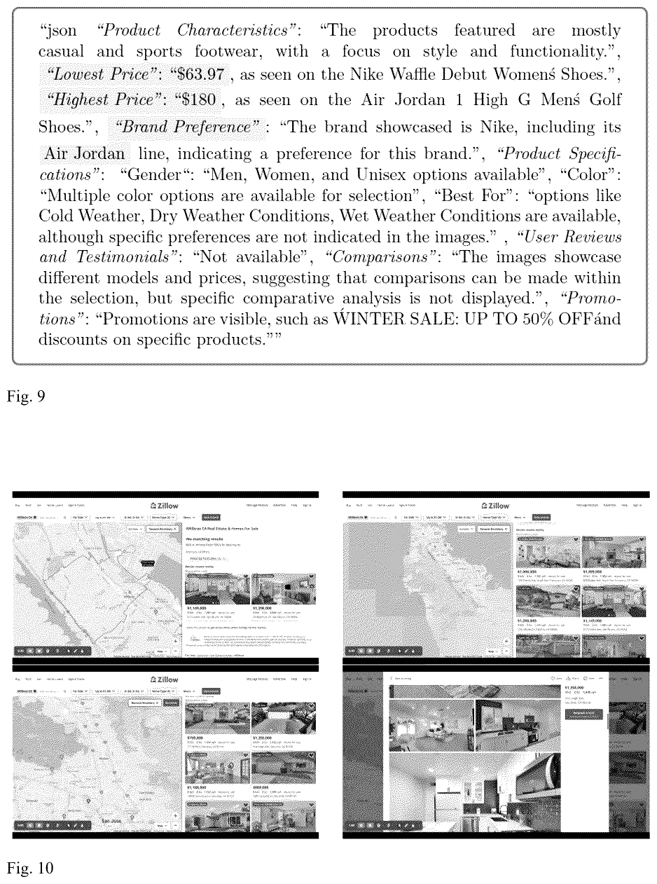

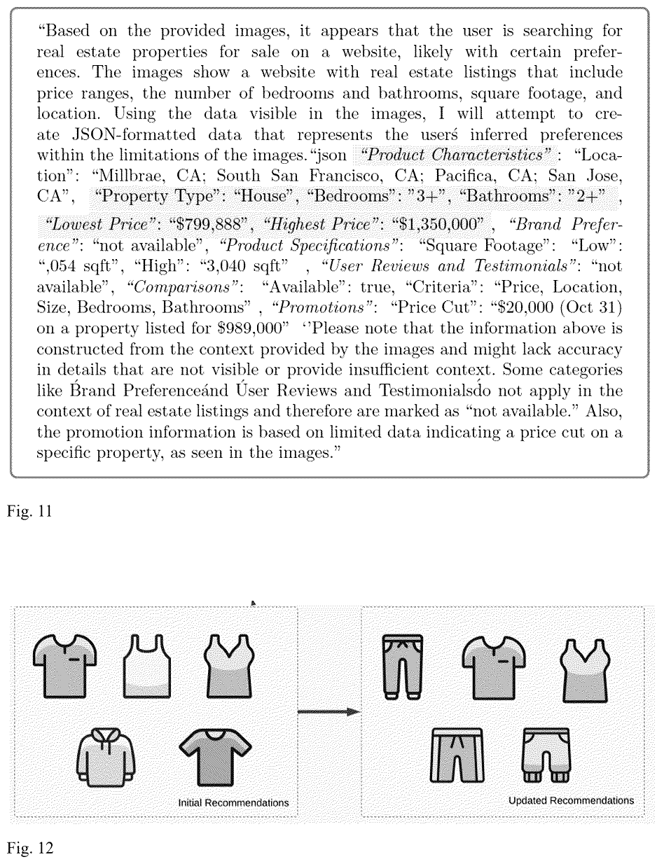

We present a dynamic process of generating personalized, real-time recommendations for users navigating the Asos fashion apparel website through an illustrative example. The recommender system (InteraRec) captures screenshots every 2 seconds, as shown in FIG. 6, and stores them in the database. It then processes these screenshots in batches of 10, due to input token size limitations, and generates keyword summaries based on provided instructions, as illustrated in FIGS. 7-11. Our approach focuses on extracting constraints like the color and price range of products. InteraRec parses the input, extracting details such as color (‘green’), lowest price (′18$′), and highest price (′144$′) by leveraging the function-calling ability of the gpt-3.5-turbo model. Using the parsed information as arguments, InteraRec executes the MNL optimization script and communicates the outcomes via the interface. We can observe the impact of incorporating user behavior in the form of updated recommendations being limited to green apparel, as shown in FIG. 12. This methodical step-by-step approach ensures consistent refinement of recommendations through continuous analysis of successive batches of images.

Experimental Validation of InteraRec with Session Based Recommendation Model Dataset

To validate the InteraRec framework with session-based recommendation model, we need a dataset comprising screenshots of users' browsing sessions. Notably, there is no publicly available dataset meeting these requirements in the existing literature. Therefore, we create a new dataset comprising of screenshots capturing user browsing sessions on the Amazon.com website. Specifically, we leverage the Amazon-M 2 (Jin et al, 2024) multilingual shopping session dataset from different regions. The dataset comprises of item IDs from anonymous user browsing sessions in chronological order of their interactions. Using the item IDs we query the AmazonUK website to retrieve the screenshots of corresponding item web pages.

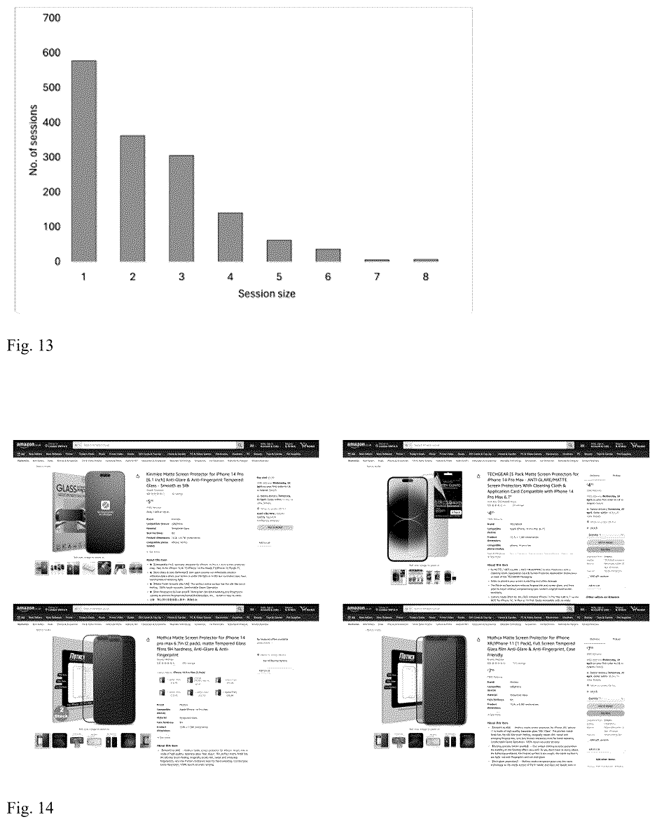

The resulting dataset contains screenshot of item web pages from 1, 500 sessions. FIG. 13 details the distribution of screenshots per session, showing that the majority of sessions contain fewer than five items. FIG. 14 illustrates the screenshots of a user browsing for screen protectors in a session. These screenshots accurately capture all the information visible to the user during their interactions.

### Popular Baselines

We evaluate the performance of several popular sequential session-based recommendation models, both in their original form and when integrated into the proposed InteraRec framework.
HRM (Wang et al, 2015) uses a hierarchical representation model to model user sessions.
GRU4Rec (Tan et al, 2016) uses a recurrent neural network to model user sessions.
NARM (Li et al, 2017) employs a hybrid encoder with an attention mechanism to model user sessions.
NPE (Nguyen and Takasu, 2018) uses a neural personalized embedding model to model user sessions.
SR-GNN (Wu et al, 2019) uses graph neural networks to model user sessions.

### Evaluation Metrics

We evaluate the quality of the recommendations using two widely-adopted rank-based metrics: Recall@k and MRR@k. Recall@k measures the proportion of instances where the relevant item is among the top-k recommended items, while MRR@k computes the average of the inverse ranks of the relevant items.

### Implementation Details

### Training Setup:

We train the baseline models using the Pytorch on a Linux machine with a 12 core, 32 GB 64-bit Intel® Core™ i7-8700 CPU @ 3.20 GHz processor, and an Nvidia Geforce GTX 1080 GPU. We use 64-dimensional embeddings to represent items. The models are optimized using Adam (Kingma and Ba, 2014) with an initial learning rate of 0.001 and a mini-batch size of 512. Hyper-parameters are tuned on the validation set, and training is terminated if the validation performance doesn't improve for 10 epochs. Finally, we report the performance of each method under its optimal hyper-parameter settings.

### Reranking Setup:

We utilize the SentenceTransformers framework to create sentence embeddings and employ gpt-4-vision-preview (GPT-4V) as our MLLM to process screenshots and generate keyword summaries.

### Results

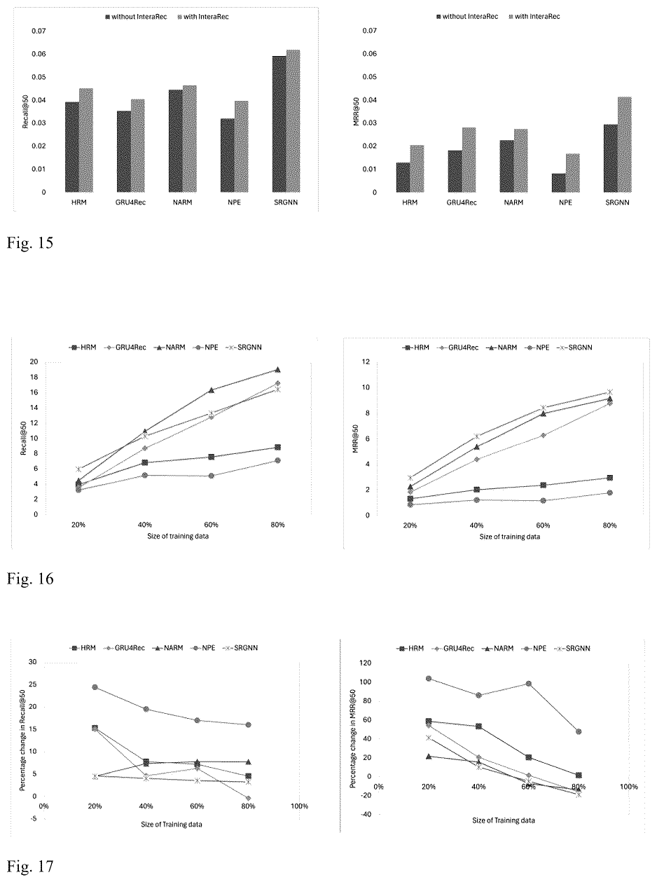

We observe performance gains across all baselines using the InteraRec framework, as indicated by the evaluation metrics MRR@50 and Recall@50, shown in FIG. 15. This demonstrates the effectiveness of the InteraRec framework in enhancing prediction rankings by incorporating additional context from keyword summaries of user browsing session screenshots.

### Effects of Augmenting Training Data

Expanding on the previous findings, we conducted a series of experiments where we incrementally augmented the size of the training dataset for all baseline models. Our results, illustrated in FIG. 16, demonstrate that the performance of all baseline models improved as the training data size grew. However, we observed a notable reduction in performance across all baselines when employing the InteraRec framework as shown in FIG. 17. This suggests that the influence of the keyword summary on re-ranking predictions diminishes as the models become more robust. This phenomenon can be attributed to the enhanced baselines' ability to indirectly capture and incorporate the information from the keyword summary into their predictions, owing to the larger training dataset.

### Effects of Exclusively Using Product Images

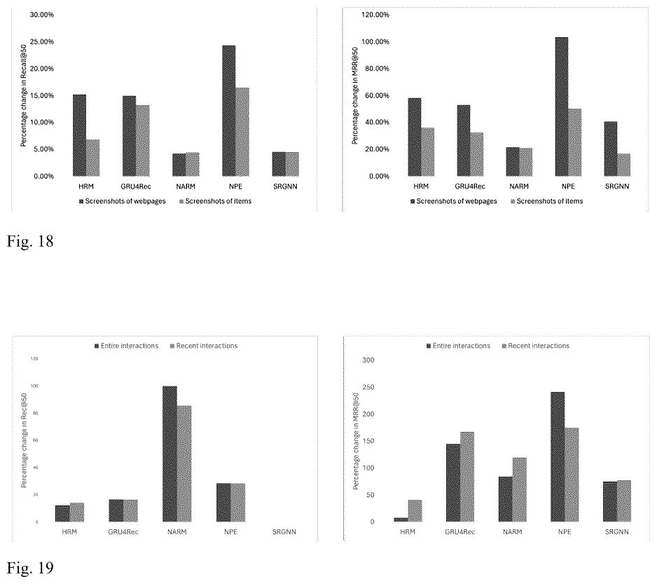

In this set of experiments, we leveraged solely the screenshots of individual items from web pages, rather than entire item web pages, as input to the InteraRec framework for generating keyword summaries representing user interests and preferences. The corresponding results are presented in FIG. 18. We observe a decrease in overall performance, as item images provide limited context compared to web pages, which contain additional information such as item titles, brands, and other specifications. This suggests that the lack of this additional data hindered the ability to generate relevant summaries, leading to a performance decline. Additionally, we observe that MLLM was able to filter out any additional noise within the screenshots of web pages.

### Effects of Limiting the Session Size

In this set of experiments, we focus on generating summaries by leveraging the recent history of interactions from a given session and compare the performance improvement to the setting where we leveraged the entire history of interactions from a session. Our results showed an improvement in performance across all baselines except for the NPE model as shown in the FIG. 19. This suggests that recent interactions have a significant influence on overall performance of the baselines, whereas using the entire interaction history may reduce the impact of recent interactions by treating all interactions with equal importance, rather than prioritizing the most recent ones.

### CONCLUSION

Disclosed is an interactive recommendation framework (InteraRec), craft personalized recommendations for users browsing on an e-commerce platform. Over-coming the limitations of extensive weblog engineering, InteraRec utilizes screenshots to capture and understand user behavior. Harnessing the capabilities of both LLM and MLLMs, InteraRec leverages insights from the screenshots and intelligently executes suitable optimization tools, translating user behavior into concise, easily interpretable recommendations for users. Furthermore, our findings demonstrate that integrating state-of-the-art session-based recommendation systems with the InteraRec framework enhances their performance. Our findings underscore the substantial potential of LLMs in the realm of recommender systems. Overall, InteraRec heralds a new era in recommendation systems driven by visual data.

The following paragraphs enumerated consecutively from 1 through 20 provide for various additional aspects of the present invention. In one embodiment, in a first paragraph:
1. A system for interactive recommendation comprising:
obtaining screenshots of user browsing
a behavioral summarization of the users' browsing history; and
a response generation reply to the user providing browser suggestions based on the behavioral summarization;
wherein an automated script systematically captures high-frequency screenshots of web pages visited by the user;
wherein a multimodal large language model (MLLM) uses the screen shots to create a summary of screenshots using predefined keywords;
wherein a large language model (LLM) transforms the summary into specific constraints/preferences intelligible to optimization tools; and
wherein the LLM recommends the preferences to the user via the LLM interface.
2. The system of paragraph 1, wherein the screenshots are confined to the user's viewing area.
3. The system of any of paragraphs 1 or 2, wherein the screenshots target the visible content that users actively engage with.
4. The system of any of paragraphs 1-3, wherein the MLLM creates a summary of the users' browser interaction using the screenshots.
5. The system of any of paragraphs 1-4, wherein the MLLM uses the summary to identify predefined categories of the users' screenshots.
6. The system of any of paragraphs 1-5, wherein the categories include product characteristics comprising lowest and highest prices, brand preferences, product specifications, user reviews, comparisons, and promotions.
7. The system of any of paragraphs 1-6, wherein the MLLM uses the categories to filter information from the screenshots to capture elements alighted with the user browsing interest.
8. The system of any of paragraphs 1-7, wherein the information is presented in a summarized JavaScript object notation (JSON) format.
9. The system of any of paragraphs 1-8, wherein the JSON format facilitates its use as a filter for subsequent processing.
10. The system of any of paragraphs 1-9, wherein the user summary is deconstructed into relevant constraints/preferences to generate optimal recommendations.
11. The system of any of paragraphs 1-10, wherein the LLM uses function-calling capabilities to decompose the user interaction summary into relevant constraints/preferences using functions comprising (FIG. 4): “name”: “get_user_recommendations”, “description”: “Generate dynamic recommendations based on the summary of user behavior”.
12. The system of any of paragraphs 1-11, wherein the LLM prides validations checks comprising range and consistency assessment of the decomposed constraints.
13. The system of any of paragraphs 1-13, wherein the constraints comprise a summary of user's behavior.
14. The system of any of paragraphs 1-13, wherein the summary comprises the type of object, price, description, and color.
15. The system of any of paragraphs 1-14 where in the LLM incorporates results of the summary as input to the user.
16. The system of any of paragraphs 1-15, wherein the LLM is gpt-3.5-turbo.
17. The system of any of paragraphs 1-16, wherein the MLLM is gpt-4-vision.
18. The system of any of paragraphs 1-17, wherein the screenshots are taken every 10 to 2 seconds.
19. The system of any of claims 1-18, wherein the screenshots are taken every 2 seconds.
20. A software package comprising the system of paragraphs 1-18.

Although the present invention has been described with reference to preferred embodiments, persons skilled in the art will recognize that changes may be made in form and detail without departing from the spirit and scope of the invention.

All publications, patents, and patent documents cited herein are incorporated by reference as though individually incorporated by reference. No limitations inconsistent with this disclosure are to be understood therefrom. The invention has been described with reference to various specific and preferred embodiments and techniques. However, many variations and modifications may be made while remaining within the spirit and scope of the invention.

What is claimed is:

1. A system for interactive recommendation comprising:
obtaining screenshots of user browsing
a behavioral summarization of the users' browsing history; and
a response generation reply to the user providing browser suggestions based on the behavioral summarization;
wherein an automated script systematically captures high-frequency screenshots of web pages visited by the user;
wherein a multimodal large language model (MLLM) uses the screen shots to create a summary of screenshots using predefined keywords;
wherein a large language model (LLM) transforms the summary into specific constraints/preferences intelligible to optimization tools; and
wherein the LLM recommends the preferences to the user via the LLM interface.

2. The system of claim 1, wherein the screenshots are confined to the user's viewing area.

3. The system of claim 1, wherein the screenshots target the visible content that users' actively engage with.

4. The system of any one of claim 1, wherein the MLLM creates a summary of the users' browser interaction using the screenshots.

5. The system of any one of claim 1 wherein the MLLM uses the summary to identify predefined categories of the users' screenshots.

6. The system of any one of claim 1, wherein the categories include product characteristics comprising lowest and highest prices, brand preferences, product specifications, user reviews, comparisons, and promotions.

7. The system of any one of claim 1, wherein the MLLM uses the categories to filter information from the screenshots to capture elements alighted with the user browsing interest.

8. The system of any one of claim 1, wherein the information is presented in a summarized JavaScript object notation (JSON) format.

9. The system of any one of claim 8, wherein the JSON format facilitates its use as a filter for subsequent processing.

10. The system of any one of claim 1, wherein the user summary is deconstructed into relevant constraints/preferences to generate optimal recommendations.

11. The system of any one of claim 1, wherein the LLM uses function-calling capabilities to decompose the user interaction summary into relevant constraints/preferences using functions comprising: “name”: “get_user_recommendations”, “description” and “Generate dynamic recommendation based/the summary of user behavior”.

12. The system of any one of claim 1, wherein the LLM prides validations checks comprising range and consistency assessment of the decomposed constraints.

13. The system of any one of claim 1, wherein the constraints comprise a summary of user's behavior.

14. The system of any one of claim 1, wherein the summary comprises the type of object, price, description, and color.

15. The system of any one of claim 1 where in the LLM incorporates results of the summary as input to the user.

16. The system of any one of claim 1, wherein the LLM is gpt-3.5-turbo.

17. The system of any one of claim 1, wherein the MLLM is gpt-4-vision.

18. The system of claim 1, wherein the screenshots are taken every 10 seconds.

19. The system of claim 1, wherein the screenshots are taken every 2 seconds.

20. A software package comprising the system of claim 1.
